(19) United States
(12) Patent Application Publication
(10) Pub. No.: US 2005/0138173 A1
(43) Pub. Date: Jun. 23, 2005

(54) Ontology-based service discovery system and method for ad hoc networks

(76) Inventors: Young Gook Ha, Daejeon (KR); Joo Chan Sohn, Daejeon (KR); Ho-Sang Ham, Daejeon (KR)

Correspondence Address: JACOBSON HOLMAN PLLC, 400 SEVENTH STREET N.W., SUITE 600, WASHINGTON, DC, 20004, US

(21) Appl. No.: 10/867,792

(22) Filed: Jun. 16, 2004

(30) Foreign Application Priority Data
Dec. 22, 2003 (KR) 10-2003-0094805

(51) Int. Cl. G06F 15/173

(52) U.S. Cl. 709/225

(57) ABSTRACT

An ontology-based ad hoc service discovery system includes a local service cache, a cache manager, a service description unit, a query processor, a service semantic inference unit and a node daemon. The local service cache restores a service ontology by collecting class information of all services advertised on an ad hoc network and stores the service ontology. The cache manager manages the local service cache and performs various preset operations on the cache. The service description unit stores a description of a corresponding service for use in initializing the local service cache. The query processor starts performing a semantic based service query protocol by receiving a service query from a user or an application program. The service semantic inference unit inspects whether the service query transmitted from a client is coincident with the content of the service. The node daemon performs a service cache synchronization protocol with neighboring nodes.

### FIELD OF THE INVENTION

The present invention relates to a method for discovering a service by using a distributed service ontology and a semantic based search query; and, more particularly, to a system and a method for effectively discovering a service on a mobile ad hoc network (MANET) made up of various kinds of services and mobile hosts.

### BACKGROUND OF THE INVENTION

A MANET also called as a mobile radio network or a multihop wireless network is a wireless network made up of mobile hosts with a high mobility. Instead of a base station or a backbone connected to a wired-network, the MANET has mobile hosts (each serving as a router) which are connected to each other via a wireless link while constituting a topology in a form of a graph and thereby forming a network. The MANET topology thus constituted changes dynamically as the mobile hosts move and, therefore, special types of routing and transport protocol, which are different from those executed in the wired network, are required in the MANET. Conventional researches on the MAMET covers various techniques: a wireless medium technique such as Bluetooth and IEEE 802.11, an effective broadcasting and multicasting method, a scalability supporting technique, various routing protocol techniques based on Quality of Service (QoS) and power-awareness, a transport protocol technique providing a reliable end-to-end connection, and so forth. Further, with the recent rising interest in ubiquitous computing, service discovery techniques in the MANET, constituted with various kinds of mobile apparatuses, starts to be developed.

A service is a broad and comprehensive term including, e.g., a concept of computing resources such as a memory, a CPU and peripheral equipments; a concept of a process such as a transaction and a business process; and a concept of a S/W component such as a proxy object. A service as a computing resource can be described by using properties such as availability and capability while a service as a process can be defined by using properties of IOPEs (input, output, precondition, effects). Further, a service as a component can be described by a S/W interface definition. A service discovery refers to a process for finding a desired service based on such service descriptions and is a very important elemental technique for securing cooperation between apparatuses involved in such an environment as a ubiquitous or pervasive computing environment where various mobile apparatuses and a variety of services offered by the mobile apparatuses exist. In other words, the effective service discovery is a critical technique in realizing cooperation between apparatuses and performing a distributed data processing under a MANET-based ubiquitous environment.

However, existing service discovery techniques are not optimized for the MANET environment which has a limited resource and a limited bandwidth but has a structure adequate for a conventional wireless environment based on a wired backbone network such as an IP-based Internet or a cellular network. Furthermore, since the existing service discovery techniques conduct a discovery of a service through a keyword matching for a directory-based or syntax-based service description, they have a drawback in that only a service exactly coincident (or partially matched) with a service query can be discovered. The present invention seeks to provide a method for enabling an effective semantic based service discovery by using a service description based on a distributed service ontology in the limited MANET environment.

The conventional service discovery techniques can be classified into three discovery models as follows.

1) Distributed Pull Technique

A distributed pull technique is a discovery method in which a client broadcasts a query corresponding to a desired service to all available hosts; among the hosts that receive the query, a host capable of providing the service requested in the query from the client sends a reply informing its location (network address or the like). Such a method has an advantage in that the desired service can always be found only if it exists on the network. However, the method also has a drawback in that it causes a waste of bandwidths due to the execution of the broadcasting. Furthermore, there may occur a problem of a broadcasting storm due to a flooding of a service request particularly in case of the MANET. An UPnP (Universal Plug-and-play) of Microsoft and a Salutation protocol of a Salutation consortium are examples of such service discovery techniques employing the distributed pull mechanism.

2) Distributed Push Technique

A distributed push technique is a discovery method in which a server capable of providing a service advertises a description of its service to all hosts periodically; a client that seeks to use the service stores the content of the advertised description in a service cache and searches the local service cache when necessary. Though such a method has an advantage in that it allows maintaining an updated view on services currently existing on the network, it causes a waste of a memory since all service descriptions advertised are stored in local caches of the client. Furthermore, there is a likelihood that another type of broadcasting problem may occur, wherein the broadcasting problem in the distributed push technique may occur by the frequent advertisement process, instead of by the flooding as in the distributed pull technique. An example of a service discovery technique employing the distributed push method is a DEAPSpace of IBM.

3) Centralized Pull Technique

A centralized pull technique refers to a discovery method in which a server capable of providing a service registers a description of its service in a certain service registry and a client who wants the service searches the service registry for the required service. Further, it is also called as a registration-based discovery technique. The service registry may advertise the location thereof on the network or may use an already-known address. Such method provides a normal service discovery structure on Internet but has a restriction that the method can be realized on the premise that at least one host capable of serving as a registry should exist on the service network. An SLP (Service Location Protocol) of IETF and a Jini of SUN Microsystems are examples of such service discovery technique employing the centralized pull method.

However, most of the aforementioned conventional service discovery techniques are developed optimized to a wired IP network, and there are found some elements inefficient to be directly applied to an ad hoc network environment not based on a stable network infrastructure and having limited bandwidths and resources. As cited before, the problem of the existing distributed pull method is that broadcasting should be conducted over the entire network for all service discovery queries. A broadcasting method using flooding is most widely employed for the MANET. In case of most of wireless MAC (Media Access) protocols (e.g., IEEE 802.11 using CSMA/CA), however, a broadcasting storm, which refers to a phenomenon where the entire network is congested, may occur due to a congestion of flooding packets. Similarly, another type of broadcasting storm due to the periodical advertisement of services may occur in the distributed push method as well. Furthermore, since caching should be conducted for all service descriptions additionally advertised, a shortage of a storing space may be caused. In the centralized pull structure, problems related to broadcasting do not occur in general but there is a restriction in this method in that at least one registry host should exist in a discovery domain. Therefore, the centralized pull method is also inappropriate for the MANET environment assuming the high mobility of hosts.

In addition to the above-descried structural problems, there is required a method for more precisely finding various mobile apparatuses and services that exist in the MANET-based ubiquitous environment, since the conventional methods employing a syntax-based service description and key word matching method cannot accomplish such demand. That is, problems related to homonyms (a searched result is not a desired service though a service keyword is matched) and synonyms (a searched result is a desired service though a service keyword is not matched) of a service discovery query may occur, and a search function capable of finding an alternative service, which means a service not quite coincident with the query but able to serve as a substitute, through an inference cannot be provided.

### SUMMARY OF THE INVENTION

It is, therefore, an object of the present invention to provide an inventive discovery system and method adequate for an ad hoc network environment by combining a distributed push technique and a distributed pull technique based on an ontology for describing semantics of distributed services.

In accordance with one aspect of the invention, there is provided an ontology-based ad hoc service discovery system including: a local service cache for restoring a service ontology by collecting class information of all services advertised on an ad hoc network and storing therein the service ontology; a cache manager for managing the local service cache and performing various preset operations on the cache; a service description unit for storing therein a description of a corresponding service for use in initializing the local service cache; a query processor for starting to perform a semantic based service query protocol by receiving a service query from a user or an application program; a service semantic inference unit for inspecting whether the service query transmitted from a client is coincident with the content of the service thereof through inference; a node daemon for performing a service cache synchronization protocol with neighboring nodes.

In accordance with another aspect of the invention, there is provided an ontology-based ad hoc service discovery method comprising the steps of: (a) allowing a client node, which newly participates in an ad hoc network, to share a service description into a service cache with neighboring nodes already being in the synchronous state through a service cache synchronization protocol; (b) rendering the client node send a service request only to servers corresponding to a service class of a service to be discovered, by using an ontology information created from the service description and stored in a local service cache, through a semantic based service query protocol; and (c) processing a service query of the service request by allowing, among the servers receiving the corresponding requests, a server matched with the service query to reply to the service request.

### BRIEF DESCRIPTION OF THE DRAWINGS

The above and other objects and features of the present invention will become apparent from the following description of a preferred embodiment given in conjunction with the accompanying drawings, in which:

FIG. 1A provides a block diagram describing an example of an ontology-based ad hoc service discovery method in accordance with a preferred embodiment of the present invention;

FIG. 1B depicts a block diagram illustrating an example of a service ontology and a service description in accordance with the preferred embodiment of the present invention;

FIG. 2 describes an example of an ontology-based ad hoc service discovery system in accordance with the preferred embodiment of the present invention;

FIG. 3 explains an example of a local service cache in accordance with the preferred embodiment of the present invention;

FIG. 4 is a block diagram illustrating an example of a local service cache management algorithm in accordance with the preferred embodiment of the present invention;

FIG. 5 describes an exemplary service cache synchronization protocol in accordance with the preferred embodiment of the present invention;

FIG. 6 illustrates an exemplary service cache synchronization protocol algorithm in accordance with the preferred embodiment of the present invention;

FIG. 7 explains a semantic based service query in accordance with the preferred embodiment of the present invention; and

FIG. 8 shows an example of a semantic based service query protocol algorithm in accordance with the preferred embodiment of the present invention.

### DETAILED DESCRIPTION OF THE PREFERRED EMBODIMENTS

A preferred embodiment of the present invention will now be described in detail with reference to the accompanying drawings.

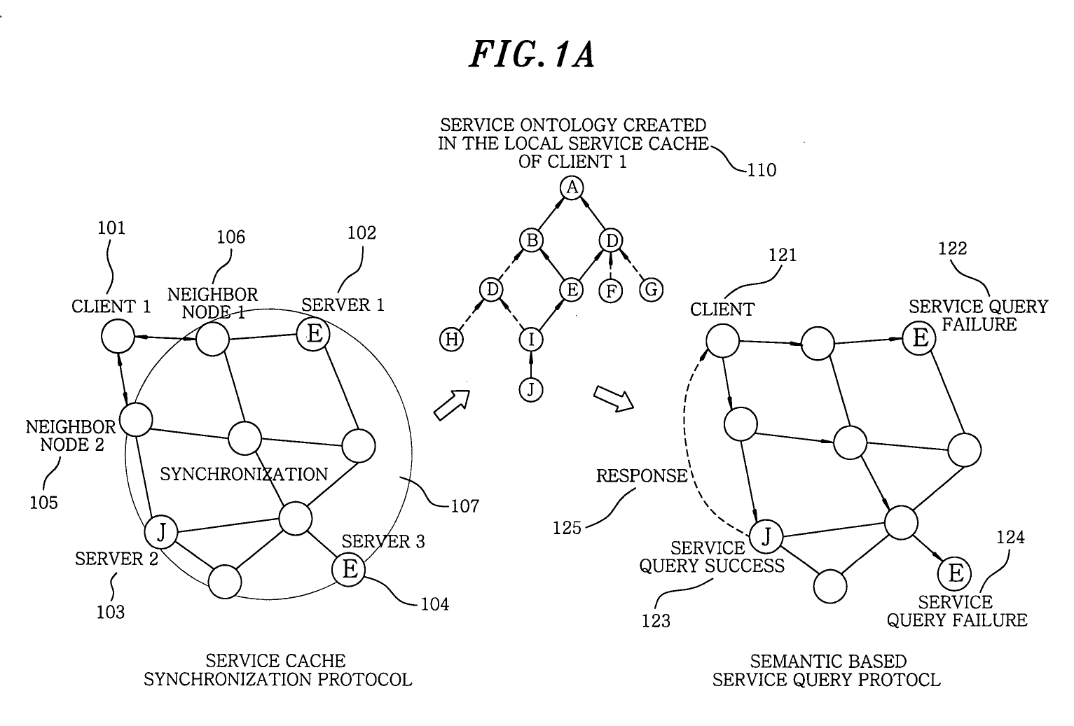

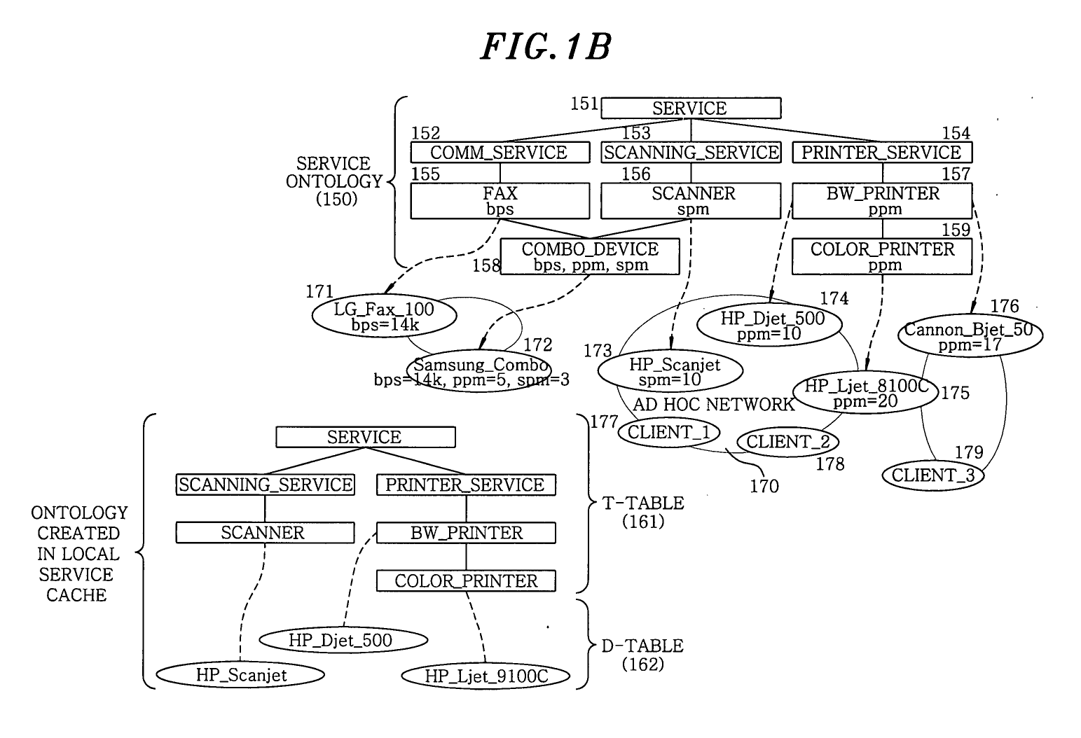

FIG. 1A describes a conception of an ontology-based service discovery in accordance with the preferred embodiment of the present invention.

In FIG. 1A, each of all servers 102 to 104 existing on an ad hoc network has a description of a service that can be provided by it based on a service ontology defined in advance. Further, all nodes including clients and servers have their own local service caches for storing therein the service descriptions provided from the servers on the network. Each node performs a service cache synchronization protocol with neighboring nodes, whereby the nodes on the entire network become to share their service descriptions with each other. The service descriptions stored in the local service caches are organically connected to each other, thereby constituting the service ontology.

Each client node is set to send a service query only to a server node of a proper class by way of inferring service ontology information cached through a semantic based service query protocol. The present invention has advantages compared with conventional methods in that it enables a further detailed description of a service and a raising of a complicated query based on the ontology; it does not cause problems due to flooding since it does not use broadcasting for the advertisement of services and the raising of queries; and it saves a network bandwidth. Further, since all the service descriptions are not stored in a service cache but only service class structure information for use in constructing the ontology is stored therein, a less amount of storage space is required.

In FIG. 1, a client node 101 newly enters the ad hoc network. Therefore, except this node, the other nodes are in a synchronous state 107 and thus become to have cache information with a same content through the service cache synchronization protocol. The synchronous state is defined as follows.

Synchronous State
: refers to a state where all nodes share ontology information about services existing on the ad hoc network while satisfying at least one of the flowing conditions:
1) only one node exists on the ad hoc network (a client or a server)
2) the contents stored in local service caches of the nodes on the ad hoc network are all same.

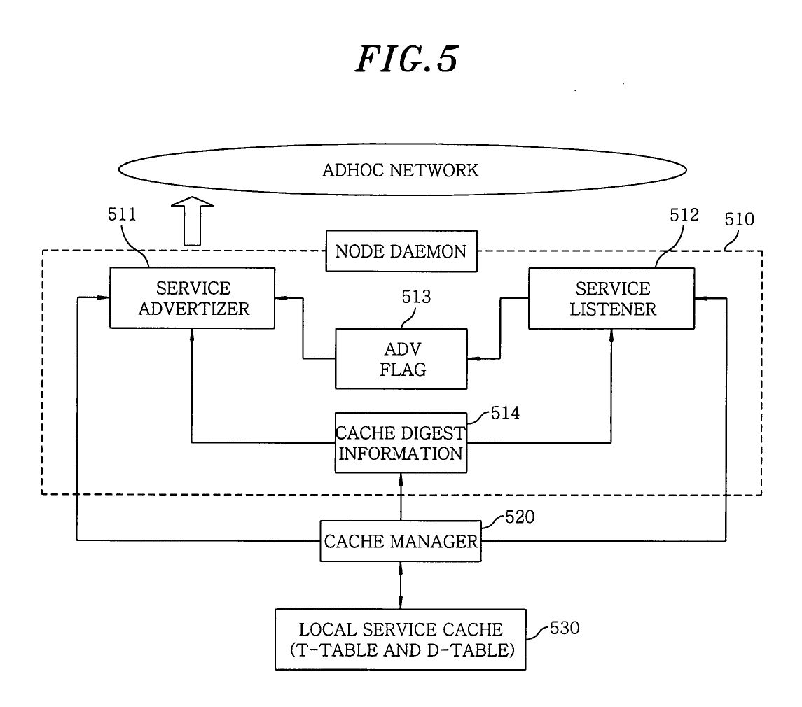

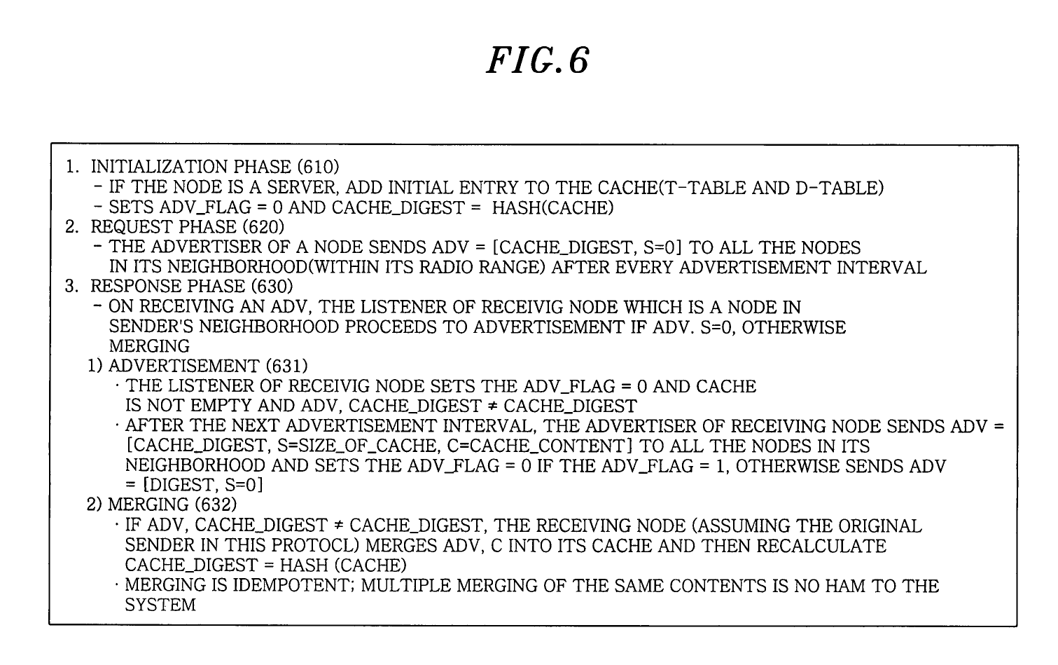

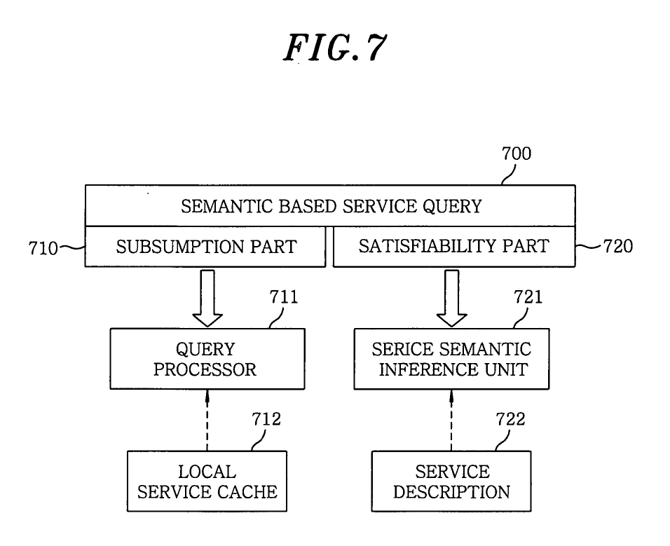

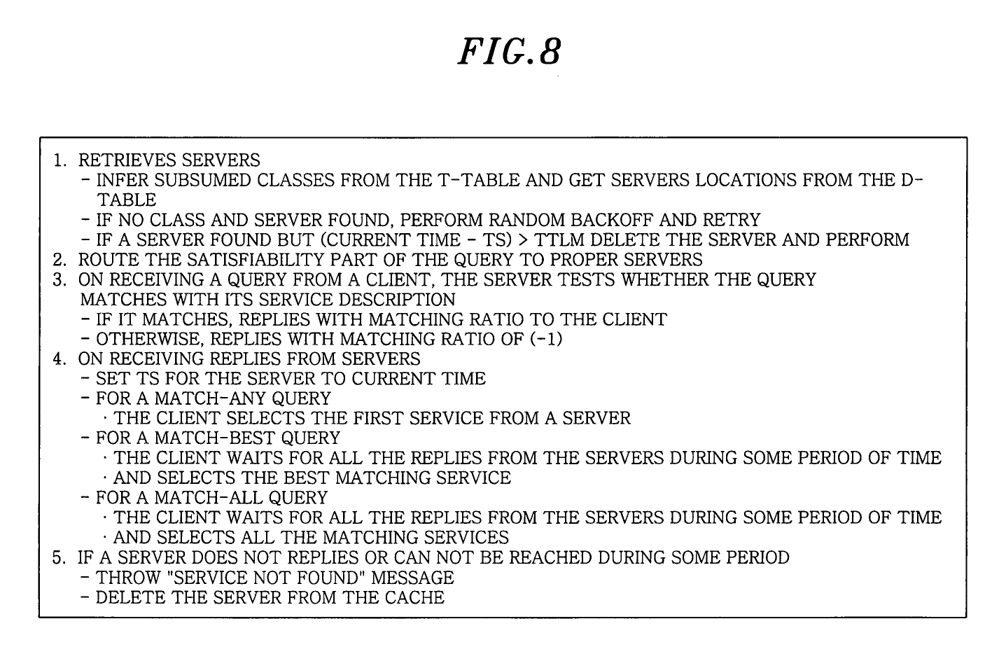

Here, assume that the ad hoc network is currently in the synchronous state and the new client 101 participates in the network. In such a case, a service query can be raised through the serial steps as follows:
1) the new client node 101 participates in the network;
2) the client node shares its service cache with neighboring nodes 105 and 106, which are already in the synchronous state, through the service cache synchronization protocol (a detailed description of which will be provided later with reference to FIGS. 5 and 6);
3) when another new node enters the network, its service cache is also shared in the same way as described and all other nodes participating in the network later are also subjected to such process;
4) once the synchronous state is obtained, no advertisement of services is made until a new node participate therein or an existing node leaves the network;
5) a client node 121 sends a service request only to servers corresponding to a desired service class based on the ontology information stored in its local cache through the use of the semantic based service query protocol (a detailed description of which will be provided later with reference to FIGS. 7 and 8);
6) among servers 122 to 124 that received the corresponding request, a server 123 matched with the service query sends a reply 125.

FIG. 1B is a drawing showing an example of a service ontology and a service description information in accordance with the preferred embodiment of the present invention.

In a service ontology 150 which is defined in advance, classes 151 to 159 of existing servers and their properties are defined and a hierarchical structure of the classes are described with the class of Service set as the highest class. A property of a class refers to a unique property thereof. For example, bps of a Fax service 155 and ppm of a B/W_Printer service 157 are examples of such class properties. These properties are inherited from a higher class to a lower class according to the hierarchical structure of the classes. Accordingly, a Combo_Device service 158 receives all the properties of its higher classes.

All server nodes create service descriptions 171 to 176 defining the services that they can provide and advertise them. In advertising, however, all the service descriptions are not advertised but only service class information is done so. The advertised service class information is shared between the interconnected nodes on the ad hoc network 170 through the service cache synchronization protocol and each of the client nodes 177 to 179 creates an ontology 160 for the service class in the form of tables 161 and 162 in its local service cache. The tables include a T-Table 161 and a D-Table 162, which is to be described later in detail. In the drawing, only the clients 177 and 178 within the range of the ad hoc network 170 share the advertised information and create the local service ontology 160. Accordingly, included in the service ontology 160 is only the service class information capable of being provided from service nodes in the ad hoc network 170 which are connected to the clients 177 and 178. The ontology 160 generated in the local service caches is employed to perform a semantic based service query protocol without broadcasting.

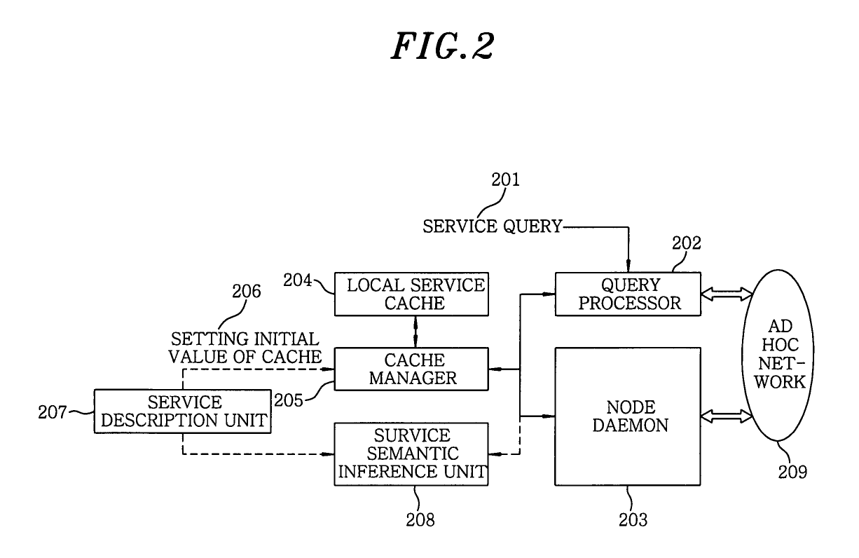

Referring to FIG. 2, there is provided a block diagram of an ontology-based ad hoc service discovery system in accordance with the preferred embodiment of the present invention.

FIG. 2 describes the entire system structure of a node but shaded parts 207 and 208 and dotted lines are elements required only in a server node. A local service cache 204 serving as a local storage space for restoring a service ontology by collecting class information for all the services advertised on the ad hoc network and storing therein thus obtained service ontology is an essential element of the inventive method provided by the present invention. A cache manager 205 is a module for managing the local service cache and performs various operations on the cache.

In case of a server node, its local service cache has a service description from a service description unit 207, wherein the service description unit 207 is also used to set an initial value of the local service cache 206 and is an entry first added in the cache and never deleted. A query processor 202 is a module for starting a semantic based service query protocol by receiving a service query 201 from a user or an application program. A service semantic inference unit 208 is a module for inspecting whether the service query transmitted from a client is coincident with the content of the service thereof through inference. A node daemon 203 is a module for performing the service cache synchronization protocol with neighboring nodes.

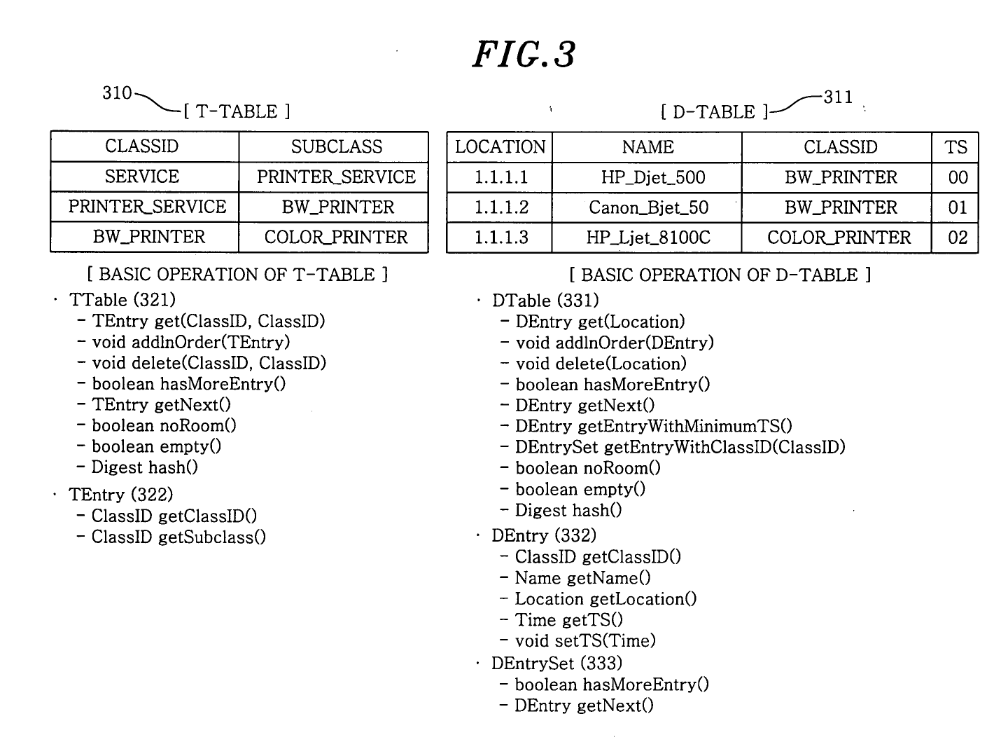

FIG. 3 describes the structure of a local service cache in accordance with the preferred embodiment of the present invention. As shown therein, the local service cache is made up of a T-Table 310 for storing therein an IS-a hierarchy (an inheritance relationship) between service classes and a D-Table 311 for storing therein server information describing servers that provide services belonging to a certain service class. T of T-Table represents Taxonomy while D of D-Table stands for Description. The reason for constituting the cache with the two tables is to manage a storage space more efficiently by way of eliminating redundant information that might appear when the cache is made up of a single table. The T-Table uses a Class ID field and a Subclass field as a key and the D-Table employs a Location field as a key.

The T-Table and the D-Table have basic operations 320 and 330, respectively. As data structures for describing the operations, the T-Table and the D-Table include a TTable 321 and a DTable 331 for indicating the T-Table and D-table themselves, and a TEntry 322 and a DEntry 332 designating a singe entry (row) included in the T-Table and the D-Table, respectively. The D-Table further includes a DEentrySet 333 showing a list of the DEntry. An operation related to each of them is as follows. Operations in accordance with the preferred embodiment of the present invention can be defined by using an interface of a Java language.
TTable: a data structure describing the T-Table
TEntry get (ClassID a, CalssID b): return an entry having a subclass with a ClassID set as a and b set as a Class ID among entries of the T-Table
void addInOrder(TEntry a): add a new entry a in the T-Table in order
void delete(ClassID a, ClassID b): delete an entry having a subclass with a ClassID set as a and b set as a Class ID among the entries of the T-Table
boolean hasMereEntry( ): return whether there still exists any entry to be restored in the T-Table
TEntry getNext( ): return a next entry of the last one restored from the T-Table
boolean noRoom( ): return whether there is a space capable of accommodating a new entry in the T-Table
boolean empty( ): return whether the T-Table is empty
Digest hash ( ): return a summary (hash code) of the content of the T-Table
TEntry: a data structure describing an entry of the T-Table
ClassID getClassID( ): return a ClassID field value of the entry of the T-Table
ClassID getSubclass( ): return a Subclass field value of the entry of the T-Table
DTable: a data structure describing the D-Table
DEntry get (Location 1): return an entry whose location is set as 1 among entries of the D-Table
void addInOrder(DEntry a): add a new entry a in the D-Table in order
void delete(Location 1): delete an entry whose location is set as 1 among the entries of the D-Table
boolean hasMereEntry( ): return whether there still exists any entry to be restored in the D-Table
DEntry getNext( ): return a nest entry of the last one restored from the D-Table
DEntry getEntryWithMinimumTS( ): return an entry having a maximum value of TS (Timestamp) from the D-Table
DEntry getEntryWithClassID(ClassID a): return all entries having a given ClassID a from the D-Table
boolean noRoom( ): return whether there is a space capable of accommodating a new entry in the D-Table
boolean empty( ): return whether the D-Table is empty
Digest hash( ): return a summary (hash code) of the content of the D-Table
DEntry: a data structure describing an entry of the D-Table
ClassID getClassID( ): return a ClassID field value of the entry of the T-Table
Name getName( ): return a Name field value of the entry of the D-Table
Location getLocation( ): return a location field value of the entry of the D-Table
Time gets( ): return a TS field value of the entry of the D-Table
void setTS(Time t): set a TS of the entry of the D-Table to have a given value of t
DEntrySet: a data structure describing a list of entries in the D-Table
boolean hasMoreEntry( ): return whether there still exists any entry to be restored in the entry list of the D-Table
DEntry getNext( ): return a next entry of the last one restored from the entry list of the D-Table

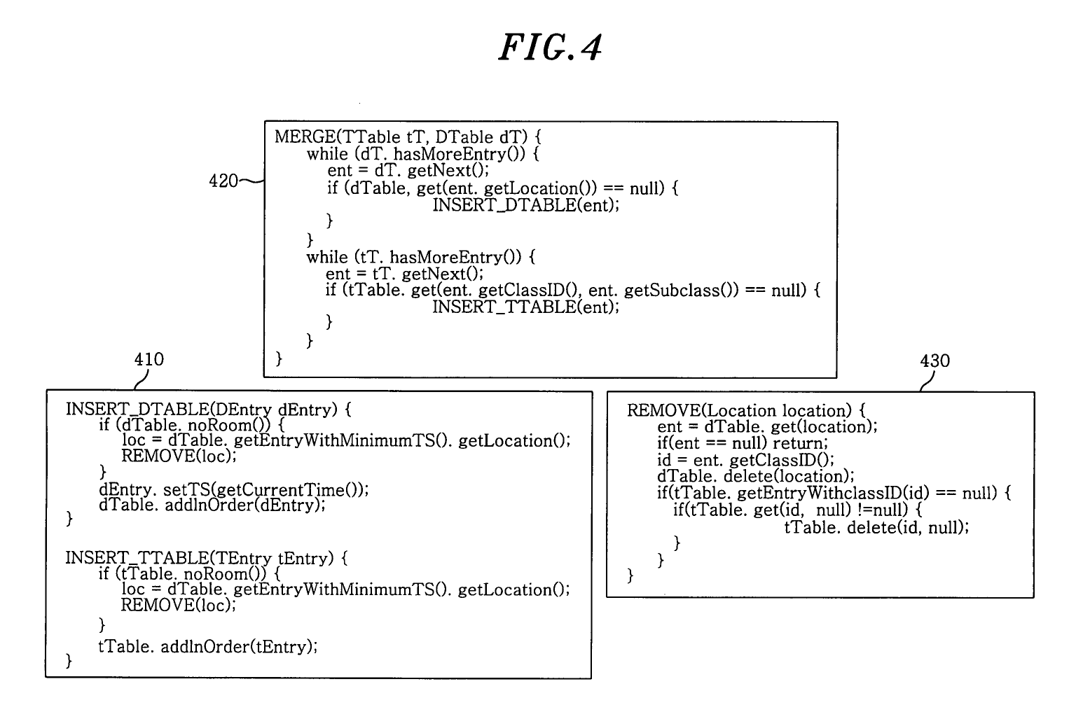

Referring to FIG. 4, there is illustrated a local service cache management algorithm in accordance with the preferred embodiment of the present invention. The algorithm is performed in the cache manager and is made up of an Insertion algorithm 410 for adding a new cache entry based on the basic operations of the T-Table and the D-Table; a Merging algorithm 420 for merging the contents of two caches; and a Removal algorithm 430 for removing existing cache entries. In this embodiment, each algorithm is defined by using a grammar of the Java language.

FIG. 5 shows the structure of a service cache synchronization protocol in accordance with the preferred embodiment of the present invention and FIG. 6 describes a service cache synchronization protocol algorithm.

The technical characteristic of the service cache synchronization protocol resides in the fact that a server node dose not broadcast its entire service description to all nodes existing on the ad hoc network but only shares its service class information with neighboring nodes through a cache synchronization and then restores an ontology for services existing on the network. Basically, the cache synchronization is carried out through the steps as follows. A node summarizes the content of its local cache through the use of a Hash function (610) and periodically advertises it only to the neighboring nodes at every ‘advertisement interval’ (620). Then, among the neighboring nodes having received the cache summary, only those whose summaries of local caches are different from the received cache summary are set to respond (631) and the node having sent the summary initially merges the received information in its cache (632). In FIG. 6, the summary of the cache is described as ‘Cache_Digest’, and an ‘ADV’ is employed as a parameter of a data structure for communication of information between the nodes.

In FIG. 5, a service advertiser 511 and a service listener 512 are parts of a node daemon 510 and are modules mounted in every node. The service advertiser 511 transmits a cache digest information 514 providing a summary of the content of a local cache 530 to neighboring nodes at a regular time interval. Stored in the cache digest information 514 is a value obtained by calculating the content of the current cache by using a Hashing algorithm (such as a MD5 or a SHA1 algorithm). An Adv flag 513 informs the service advertiser whether the content of the cache will be transmitted together with the cache digest information. The service listener receives service advertisements sent from the neighboring nodes and determines whether or not to set the Adv flag.

FIG. 7 illustrates the structure of a semantic based service query in accordance with the preferred embodiment of the present invention. In order to perform a semantic based query 700 for a service in a semantic based service protocol, the query needs to be processed while being divided into a subsumption part 710 and a satisfiability part because the local service cache stores therein only the information upon a subsumption hierarchy of service classes.

That is, when assuming a service description as follows, for example, a given service query is divided into a subsumption part and a satisfiability part as follows.
Advertised service descriptions
/Service/Printer_Service/BW_Printer/HP_DJet_{—}500.ppm=10
/Service/Printer_Service/BW_Printer/Canon_Bjet_{—}50.ppm=17
/Service/Printer_Service/BW_Printer/Color_Printer/HP_L Jet_{—}8100C.ppm=20
Service query: Find/Service/Printer_Service.ppm>15
Subsumption part: /Service/Printer_Service
Statisfiability part: ppm>15

If a local service cache is constituted from the advertised service descriptions, the T-Table 310 and the D-Table 311 shown in FIG. 3 are generated. In the above example, the subsumption part 710 conducts a forward chaining on an IS-A relationship from the class hierarchy information (T-Table) stored in the local service cache 712 through the query processor 711, thereby finding that the service classes having Printer-Service as their superior concept are BW_Printer and Color_Printer. If a corresponding service class is not found in the local cache, a GLBS (Greatest Lower Bound Set) policy for selecting an optimum lower concept service instead or a LUBS (Lowest Upper Bound Set) policy for selecting an optimum upper concept service instead can be employed. In the above example, the query protocol of the semantic based service is operated in a manner that the location of servers providing services corresponding to the BW_Printer and the Color_Printer are searched from the D-Table of the local service cache based on the advertised service descriptions; the satisfiability part 720 of the query is then transmitted only to the corresponding servers; and it is determined whether the satisfiability part is coincident with the service description 722 through the use of the service semantic inference unit 721 of the server. As a result, replies are received from print servers 1.1.1.2 and 1.1.1.3 which satisfy the condition of ppm>15. FIG. 8 shows an example of a semantic based service query protocol algorithm in accordance with the preferred embodiment of the present invention, which describes the semantic based service query protocol in further detail. The algorithm includes a first step of retrieving a server to which a service query is to be sent by using the T-Table 310 and the D-Table 311, a second step of sending a satisfiability part only to the retrieved server, a third step of determining whether the satisfiability part is coincident with a service description of the server and, if so, sending a reply; and a fourth and a fifth step of processing the reply provided from the server.

As described above, most of conventional service discovery techniques are based on wired IP networks and shows many structural problems when directly applied in an ad hoc network environment which is not based on a stable network infrastructure and has limited bandwidths and resources. Further, besides such problems, it is required to develop a method capable of accurately retrieving a desired sever in order to effectively find various mobile apparatuses and all possible services that may exist in a ubiquitous environment. However, conventional grammar-based service description and key word matching methods cannot satisfy such a requirement. Thus, in order to solve the above problems and suggest a service discovery technique adequate for the ad hoc network environment, the present invention provides a service cache synchronization protocol combining a distributed push method and a distributed pull method and a semantic based service query protocol based on an ontology for describing semantics of distributed services, thereby providing foundational techniques for the efficient communication and cooperation between various mobile apparatuses in the ubiquitous environment and thus making it possible to perform various computing works and offer services effectively.

While the invention has been shown and described with respect to the preferred embodiment given in conjunction with the drawings, it will be understood by those skilled in the art that various changes and modifications may be made without departing from the spirit and scope of the invention as defined in the following claims.

1. An ontology-based ad hoc service discovery method comprising the steps of:
(a) allowing a client node, which newly participates in an ad hoc network, to share a service description into a service cache with neighboring nodes already being in the synchronous state through a service cache synchronization protocol;
(b) rendering the client node send a service request only to servers corresponding to a service class of a service to be discovered, by using an ontology information created from the service description and stored in a local service cache, through a semantic based service query protocol; and
(c) processing a service query of the service request by allowing, among the servers receiving the corresponding requests, a server matched with the service query to reply to the service request.

2. The method of claim 1, wherein the step (a) further includes rendering no service advertisement made until a new node is added or an existing node leaves the network, once a synchronous state is obtained by sharing the service description.

3. The method of claim 1, wherein the step (b) further includes allowing each client node to send a service query only to a server node of a service class by inferring service ontology information stored in a service cache through a semantic based service query protocol and to store therein only service class structure information for constituting ontology.

4. The method of claim 1, wherein the server in the ad hoc network has a description of services thereby provided based on predefined service ontology in the step (b).

5. The method of claim 1, wherein all nodes including the client and the servers have local service caches to store therein service descriptions advertised from the servers on the network.

6. The method of claim 1, wherein each node on the ad hoc network performs a service cache synchronization protocol with neighboring nodes, whereby each node on the entire network becomes to share service descriptions thereof and to form service ontology from the service descriptions stored in the local service caches connected to each other.

7. The method of claim 6, wherein the synchronous state of the service cache synchronization protocol refers to a state in which all nodes share ontology information on the services existing in the ad hoc network, and there exists only one node in the ad hoc network or all the nodes on the ad hoc network have same contents in the local service caches thereof.

8. The method of claim 1, wherein the service cache synchronization protocol is performed in a manner that each node shares information on a service class through a cache synchronization with neighboring nodes and restoring ontology on service existing in the network; and the cache synchronization includes the steps of:
digesting the content of the local cache of each node by using a Hash function and periodically advertising a cache digest only to the neighboring nodes;
allowing, among the neighboring nodes, only the nodes whose digested content of local caches are different from the received cache digest to reply; and
rendering the node that advertised the ache digest to merge the content of the reply in the cache thereof.

9. The method of claim 1, wherein the semantic based service query protocol is characterized in that a given query is divided into a subsumption part and a satisfiability part and subjected to a distribution processing;
only subsumption hierarchy information upon a service class is stored in a local service cache;
the subsumption part performs a forward chaining upon an IS-A relationship from class hierarchy information (T-Table) stored in the local service cache through a query processor of a client;
a GLBS (Greatest Lower Bound Set) policy for selecting an optimum lower concept service instead or a LUBS (Lowest Upper Bound Set) for selecting an optimum upper concept service instead when the corresponding service class does not exist in the local cache;
a location of a server providing a service inferred from the T-Table of the local cache is retrieved from a D-Table of the local cache and the satisfiability part of the query is sent to the corresponding server; and
it is inspected whether the satisfiability part is coincident with a service description of the server through a service semantic inference unit thereof and informs the client of the result.

10. The method of claim 6, wherein the service ontology defines classes and properties of existing services and describes a hierarchical inheritance structure of the classes with a class of Service set as the highest class, the class of Service being a unique property every class has and is inherited from an upper class to a lower class.

11. The method of claim 6, wherein all server nodes based on the service ontology create descriptions of services that can be provided therefrom and advertises, among the service descriptions, only the service class information shared between neighboring nodes that are connected through a cache synchronization.

12. The method of claim 6, wherein the client nodes create the ontology for the service class in the form of tables in its local service cache by using the advertised information and the ontology generated in the local service cache is not broadcast but is used to perform a semantic based service query protocol.

13. An ontology-based ad hoc service discovery system comprising:
a local service cache for restoring a service ontology by collecting class information of all services advertised on an ad hoc network and storing therein the service ontology;
a cache manager for managing the local service cache and performing various preset operations on the cache;
a service description unit for storing therein a description of a corresponding service for use in initializing the local service cache;
a query processor for starting to perform a semantic based service query protocol by receiving a service query from a user or an application program;
a service semantic inference unit for inspecting whether the service query transmitted from a client is coincident with the content of the service thereof through inference;
a node daemon for performing a service cache synchronization protocol with neighboring nodes.

14. The method of claim 13, wherein the node daemon includes:
a service advertiser for transmitting a cache summary of the content of the local cache to the neighboring nodes at a regular time interval; and
a service listener for receiving service advertisements sent from the neighboring nodes and determining whether or not to set an Adv flag indicating whether or not to send the real content of the cache along with the cache summary.

15. The method of claim 14, wherein stored in the cache summary is a value obtained by calculating the content of the current cache by using a Hashing algorithm (such as a MD5 or a SHA1 algorithm).

16. The method of claim 13, wherein the local service cache includes:
a T-Table for storing therein an IS-a hierarchical structure (an inheritance relationship) between service classes; and
a D-Table for storing therein server information describing servers that provide services belonging to the service classes,
wherein the T-Table uses a Class ID field and a Subclass field as a key and the D-Table employs a Location field as a key; each of the T-Table and the D-Table has basic operations; data structures for describing the operations of the T-Table and the D-Table have a TTable and a DTable for indicating the T-Table and D-table themselves, and a TEntry and a DEntry designating a singe entry (row) of the T-Table and the D-Table, respectively; and the D-Table further has a DEentrySet showing a list of the Dentry.

17. The method of claim 16, wherein the operations related to the T-Table of the local service cache include:
the TTable serving as a data structure describing the T-Table;
a TEntry get (ClassID a, CalssID b) method for returning an entry having a subclass with a ClassID set as a and b set as a Class ID among entries of the T-Table;
a void addInOrder(TEntry a) method for adding a new entry a in the T-Table in order;
a void delete(ClassID a, ClassID b)method for deleting an entry having a subclass with a ClassID set as a and b set as a Class ID among the entries of the T-Table;
a boolean hasMereEntry( ) for returning whether there still exists any entry to be restored in the T-Table;
a TEntry getNext( ) method for returning a next entry of an entry restored from the T-Table last;
a boolean noRoom( ) method for returning whether there is a space capable of accommodating a new entry in the T-Table;
a boolean empty( ) method for returning whether the T-Table is empty; and
a Digest hash( ) method for returning a summary (hash code) of the content of the T-Table.

18. The method of claim 16, wherein the TEntry serving as the data structure for describing an entry of the T-Table includes:
a ClassID getClassID( ) method for returning a ClassID field value of the entry of the T-Table; and
ClassID getSubclass( ) for returning a Subclass field value of the entry of the T-Table.

19. The method of claim 16, wherein the operations related to the D-Table of the local service caches include:
the DTable serving a data structure describing the D-Table;
a DEntry get (Location 1) method for returning an entry whose location is set as 1 among entries of the D-Table;
a void addInOrder(DEntry a) method for adding a new entry a in the D-Table in order;
a void delete(Location 1) method for deleting an entry whose location is set as 1 among the entries of the D-Table;
a boolean hasMereEntry( ) method for returning whether there still exists any entry to be restored in the D-Table;
a DEntry getNext( ) method for returning a next entry of the entry restored from the D-Table last;
a DEntry getEntryWithMinimumTS method for returning an entry having a maximum value of TS (Timestamp) from the D-Table;
a DEntry getEntryWithClassID(ClassID a) method for returning all entries having a given ClassID a from the D-Table;
a boolean noRoom( ) method for returning whether there is a space capable of accommodating a new entry in the D-Table;
a boolean empty( ) method for returning whether the D-Table is empty; and
a Digest hash( ) method for returning a summary (hash code) of the content of the D-Table.

20. The method of claim 19, wherein the DEntry serving as the data structure describing the entry of the D-Table includes:
a ClassID getClassID method for returning a ClassID field value of the entry of the T-Table;
a Name getName( ) method for returning a Name field value of the entry of the D-Table;
a Location getLocation( ) method for returning a location field value of the entry of the D-Table;
a Time getTS( ) method for returning a TS field value of the entry of the D-Table; and
a void setTS(Time t) method for setting a TS of the entry of the D-Table to have a given value of t.

21. The method of claim 16, wherein the DEntrySet serving as the data structure describing the list of the entries of the D-Table includes:
a boolean hasMoreEntry( ) method for returning whether there still exists any entry to be restored in the entry list of the D-Table; and
a DEntry getNext( ) method for returning a next entry of an entry restored from the entry list of the D-Table last.

22. The method of claim 13, wherein the local service cache management algorithm for use in the local service cache manager includes an insertion algorithm for adding a new cache entry based on the basic operations of the T-Table and the D-Table; a Merging algorithm for merging the contents of two caches; and a Removal algorithm for removing existing cache entries.
